(19) United States
(12) Patent Application Publication
(10) Pub. No.: US 2003/0179317 A1
(43) Pub. Date: Sep. 25, 2003

(54) Personal audio-synchronizing device

(76) Inventor: Dwight L. Sigworth, Tigard, OR (US)

Correspondence Address: KOLISCH HARTWELL, P.C., 520 S.W. YAMHILL STREET, SUITE 200, PORTLAND, OR, 97204, US

(21) Appl. No.: 10/392,620

(22) Filed: Mar. 19, 2003

Related U.S. Application Data
(60) Provisional application No. 60/366,918, filed on Mar. 21, 2002.

(51) Int. Cl. H04N 9/475

(52) U.S. Cl. 348/515

(57) ABSTRACT

An audio-synchronizing device, system and method are provided. The audio synchronizing device includes an audio input unit configured to receive an audio signal, a user-adjustable control configured to enable a user to personally modify the audio signal to produce a modified audio signal corresponding to a video display broadcast, and an audio output unit configured to output the modified audio signal to an output device.

### CROSS-REFERENCE TO RELATED APPLICATIONS

This application claims priority from U.S. Provisional Patent Application Serial No. 60/366,918 of Dwight L. Sigworth for an AUDIO-SYNCHRONZING DEVICE, filed Mar. 21, 2002, the disclosure of which is hereby incorporated by reference.

### FIELD OF THE INVENTION

The present invention relates generally to the field of audio devices, and more particularly, to an audio-synchronizing device.

### BACKGROUND

Twenty to forty years ago, it was easy to turn down the volume on a television, turn on a radio play-by-play, and simultaneously listen to a radio broadcast and watch a television broadcast of the same event. Since both signals were received over the air (via antennas), the radio broadcast and video (television) broadcast were substantially synchronized. For example, a local radio station's broadcast was typically a half second or so faster than a national television broadcast of the same event. However, the two broadcasts were substantially similar that a viewer was able to enjoy the radio broadcast while watching the television broadcast. Moreover, on some regional television broadcasts, the radio broadcast and television broadcast would be almost synchronized.

With the advent of super stations, satellites, cable systems, and enhanced television processing, television broadcasts began to lag behind radio broadcasts. Today, the lag time between the television broadcast and the radio broadcast may be as much as ten seconds, and such lag time may increase in the future. Such lag times are significant enough to effect a viewer's enjoyment of listening to a radio broadcast while watching the television video broadcast. Moreover, the length of the video delay varies substantially among different cable, dish systems, or over-the-air broadcasting. Regardless of the length of the delay, typically the radio broadcast is faster than the television broadcast making it very difficult for a viewer to listen to a favorite play-by-play announcer from a radio broadcast while simultaneously watching the television broadcast.

### SUMMARY

An audio-synchronizing device, system and method are provided. The audio synchronizing device includes an audio input unit configured to receive an audio signal, a user-adjustable control configured to enable a user to personally modify the audio signal to produce a modified audio signal corresponding to a video display broadcast, and an audio output unit configured to output the modified audio signal to an output device.

### BRIEF DESCRIPTION OF THE DRAWINGS

FIG. 1 is a schematic representation of a system for synchronizing an audio broadcast with a video broadcast according to an embodiment of the present invention.

FIG. 2 is a block diagram of an adjustable audio-synchronizing device according to an embodiment of the present invention.

FIG. 3 is a schematic representation of exemplary environments in which an audio-synchronizing device may be used.

FIG. 4 is a flow chart of a method for selectively synchronizing an audio broadcast with a video broadcast.

### DETAILED DESCRIPTION

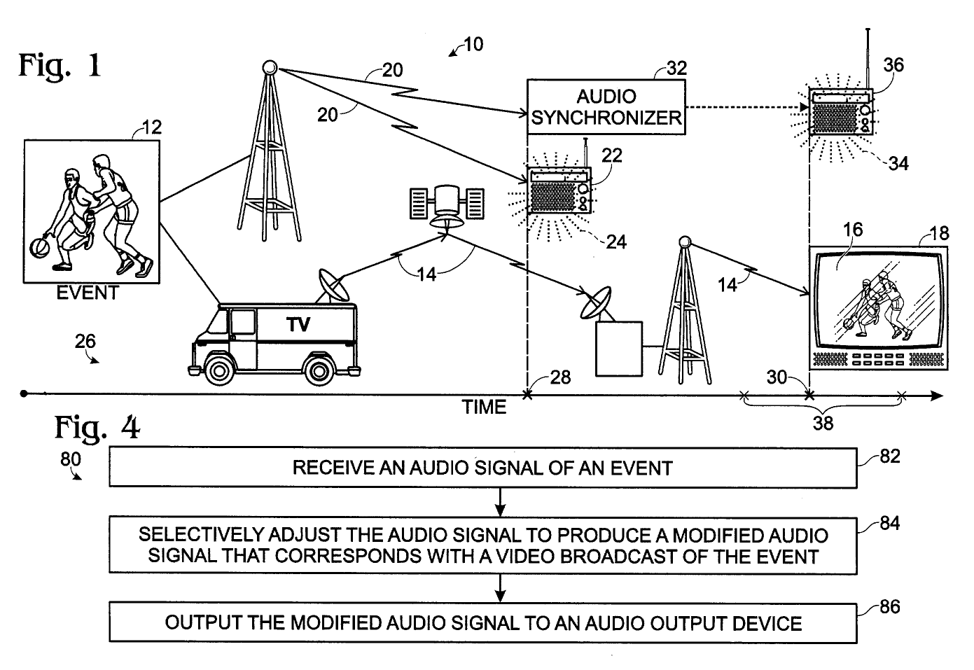

Referring initially to FIG. 1, one embodiment of the present invention provides, as shown generally at 10, an adjustable audio-synchronizing device configured to enable a user to adjust an audio broadcast to temporally match a video broadcast of the same event. As described in more detail below, the audio-synchronizing device enables an audio broadcast of an event 12, such as a radio or Internet broadcast of event 12, to be selectively synchronized with a television broadcast of event 12. It should be appreciated that event 12 may be any suitable event, which is recorded and transmitted to both audio and display devices, including, but not limited to, sporting events, speeches, concerts, plays, parades or other live events.

Multiple sources may record and transmit audio and video signals of event 12. For example, a television station may transmit a video display signal 14 of event 12 producing a video display broadcast 16 on a display device 18. It should be appreciated that video display signal 14, as used herein, may be a portion of a television broadcast that includes both an audio signal and a video display signal. The video display signal is the signal adapted to generate images on a display, such as a television, a computer, etc.

Simultaneously, with transmission of video display signal 14, one or more discrete audio signals, such as audio signal 20, may be transmitted from the event. As used herein, audio signal 20 includes any audio signal that is transmitted independently of video display signal 14. For example, audio signal 20 may be a radio transmission, including an FM transmission, or an AM transmission, a satellite transmission, an Internet broadcast, or other suitable audio transmission. The audio signal may be received by an audio device 22 which may be configured to produce an audio broadcast 24 of event 12. The audio broadcast may be played on any appropriate audio device adapted to receive the audio signal, including, but not limited to, a radio, a computer, a stereo system, a television, or other sound-generation device or system.

It should be noted that the audio signal 20 (configured to produce audio broadcast 24) may be received by audio device 22 prior to video display signal 14 (configured to produce video display broadcast 16) is received by display device 18. It should be appreciated that there may be many reasons for the delay in receiving video display signal 14. For example, and as illustrated, video display signal may be transmitted through multiple satellites and network stations prior to be transmitted to a user's display device. A timeline 26 is provided in FIG. 1 to show the temporal relationship between production of audio broadcast 24 and video display broadcast 16. Specifically, audio broadcast 24 may occur at Time 1 (indicated at 28) and video display broadcast 16 may occur at a later time, Time 2 (indicated at 30). This delay may be frustrating to a user who attempts to listen to audio broadcast 24 of event 12 while watching display broadcast 16 on display device 18.

The current system provides a device configured to enable a user to selectively modify the timing of the production of the audio broadcast on a select audio device relative to the production of the video display broadcast on a display device. As illustrated, audio signal 20 may be received by an audio synchronizer or audio-synchronizing device 32. Audio synchronizer 32 may be configured to receive audio signal 20 to produce a modified audio broadcast 34 on an associated audio device 36. It should be appreciated that audio synchronizer 32 is a personal device configured to enable an end-user, watching a video display broadcast of an event, to personally synchronize an audio broadcast to the event. As described in more detail below, audio synchronizer 32 may be external of audio device 36. Alternatively, in some embodiments, audio synchronizer 32 may be integrated within audio device 36.

Typically, audio synchronizer 32 is used to temporally adjust the audio broadcast from Time 1 (at 28) to Time 2 (at 30). Thus, the modified audio broadcast 34 may selectively correspond in time with video display broadcast 16. For example, a user may selectively delay the audio signal to produce a modified audio broadcast of event 12 on their radio, where the modified audio broadcast generally corresponds in time to a television broadcast of the same event. As a first non-limiting example, a user may use audio synchronizer 32 to selectively delay a radio broadcast of a sporting event relative to the television broadcast of the sporting event. The user may thus selectively listen to a local or favorite sports announcer call a game while watching the game on a national television station. As a second non-limiting example, a user may use audio synchronizer 32 to delay an audio broadcast of simulcast concerts and plays, as well as other events, where the user wishes to listen to audio from one source and watch video from another source, where the audio is not synchronized with the video. Thus, the user may personalize the timing of the audio broadcast to their liking.

As described above, a user may selectively adjust the audio signal to produce a modified audio broadcast that generally matches with a television broadcast. It should be appreciated that a user further may be able to adjust the audio signal to produce an audio broadcast that occurs prior to or after the video display broadcast. For example, a user may be able to adjust the timing of the audio broadcast such that it plays within a range 38 relative to the video display broadcast. The range may be any suitable range. For example, in some embodiments, a user may be able to delay the audio broadcast 2 to 100 seconds from the original audio broadcast. Some embodiments may have more narrow ranges, such as a range of 6 to 20 seconds from the original audio broadcast. Thus, a user may be able to delay the modified audio broadcast 6 to 20 seconds from the original audio broadcast. Although only a short range is illustrated at 38, it should be appreciated that the range may be longer or shorter depending on the configuration and/or use of the device.

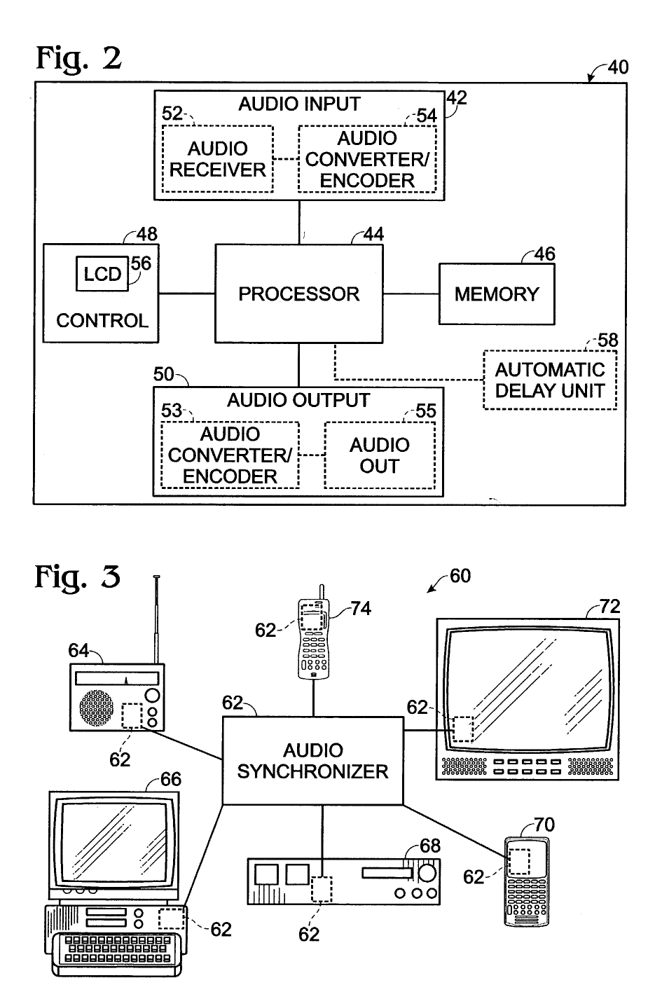

A simplified block diagram of an audio synchronizer is indicated generally at 40 in FIG. 2. Audio synchronizer 40 typically includes an audio input unit or audio input 42, a processor 44, memory 46, control 48, audio output unit or audio output 50. As briefly described, audio synchronizer 40 may be external of the audio device configured to reproduce the audio broadcast. Alternatively, in some embodiments, audio synchronizer 40 may be integrated within the audio device configured to reproduce the audio broadcast.

Audio input 42 may be configured to receive an audio signal of an event. In some embodiments, audio input 42 may include an audio receiver 52 and/or an audio converter or encoder 54. Specifically, audio receiver 52 may be configured to receive an audio signal. As described above, the audio signal may be any audio broadcasted signal. For example, the audio signal may be a radio broadcast, an Internet broadcast, or other suitable live audio signal. The audio signal may be transmitted to the audio synchronizer via a connector, such as a wired connector, or wirelessly. For example, in some embodiments, audio receiver 52 may be a wireless receiver adapted to receive an audio signal transmitted wirelessly.

In some embodiments the audio signal may be an analog signal. Audio receiver 52 may be adapted to receive the analog signal. Audio converter 54 may be configured to convert the analog signal to a digital signal, or vice versa. It should be appreciated that in some embodiments, the audio signal may be maintained as an analog signal. In some embodiments, an audio encoder may be used to encode the signal.

As described above, audio synchronizing device 40 further includes a processor 44. Processor 44 may be any suitable processing unit, such as a microprocessor adapted to control the modification of the audio signal. Processor 44 may be linked to memory 46, which may be configured to temporarily store the audio signal. Memory 46 may include both volatile memory and non-volatile memory. Non-volatile memory may be utilized for storing permanent or semi-permanent data related to operation of the audio synchronizing device. The non-volatile memory may be any suitable type of non-volatile memory, including, but not limited to, ROM, PROM, EPROM, EEPROM, Flash memory and combinations thereof. Memory 46 further may include volatile memory, which may be configured to temporarily store the audio signal. Volatile memory may include one or more suitable types of volatile memory, such as SRAM or DRAM.

In operation, audio input 42 receives and converts an audio signal. The audio signal may be temporarily stored within memory 46. The storage period may be selected using a control 48 linked to processor 44. Control 48 may be configured to receive user instructions regarding a user modification of the audio signal. Processor 44 is further configured to receive user instructions from control 48 and modify the audio signal accordingly to produce a modified audio broadcast.

In some embodiments, control 48 may be a user input device, such as user selection buttons, wherein the user may selectively modify the audio signal. Thus, the control may be configured to receive user instructions regarding modification of the audio signal, such as delaying the audio signal for a selected period of time. The user instructions may be based on the user's desire to substantially synchronize a television broadcast of the event being broadcasted.

For example, the user may be able to delay the audio broadcast by various increments depending on a user's preference. For example, a user may adjust the audio in 1/10 of a second increments. It should be noted that control 48 may include presets (manufacture set or user set), which may be used repeatedly to modify different audio broadcasts by a predetermined period.

A display 56 may be associated with control 48. Display 56 may be adapted to enable a user to define a user-selected delay period. The display may include numerical and/or graphical representations to indicate the delay period, such that the display is a time-modification display. The display may be any suitable display, such as a liquid crystal display (LCD). For example, the display may show user selections and information regarding modification of the audio signal, including, but not limited to, information regarding the period of delay, the origination audio station, the event, the volume, etc. Some displays may include user-selectable options regarding modification of the audio signal, such as an on-screen delay-time-choosing function.

After a user-defined period of time, the audio signal may be transferred from memory 46 to audio output 50. Audio output 50 may be configured to output the modified audio broadcast to a coupled audio output device. The audio output device may be integrated within the audio synchronizer or external to the audio synchronizer. Audio output 50 may include an audio converter/encoder 53 and an audio out 55. For example, in some embodiments, the delayed audio signal may have to be converted from a digital signal to an analog signal prior to output to audio out 55, or vice versa.

The modified audio signal may be transmitted from audio out 55 to an audio output device (not shown in FIG. 2). In some embodiments, the modified audio signal may be wirelessly transmitted to the audio output device. Thus, wireless technology, as known in the art, may be used to transmit both the input audio signal to the audio synchronizer, and/or the modified audio signal to an audio output device. Thus, the audio synchronizer may include one or both of a wireless receiver and/or a wireless transmitter.

In some embodiments, the audio synchronizer further may include an FM transmitter configured to enable the modified audio signal to be transmitted to an FM tuner or similar device. In such an embodiment, the modified audio broadcast may be heard through conventional speakers or headphones linked to the audio device receiving the modified audio signal.

In some embodiments audio synchronizer 40 may include an automatic delay unit 58. Automatic delay unit 58 may be linked with the display device and may provide a means for automatically determining the appropriate delay period for the audio broadcast to generally correspond with a video display broadcast of the same event. Tags, markers, or other signals in the video display signal may be used to determine the appropriate delay period. However, other suitable methods may be used to automatically synchronize the audio broadcast with a specific video display broadcast.

FIG. 3, schematically illustrates at 60, exemplary environments in which audio synchronizer 62 may be employed. It should be appreciated that audio synchronizer 62 typically is a configured to enable an individual (end-user) to personally adjust the audio broadcast to correspond to a video display broadcast. In some embodiments, audio synchronizer 62 is a stand-alone device configured to selectively receive an audio signal, modify the audio signal and output the modified output signal. The modified output signal may be reproduced by the stand-alone audio synchronizer or may be reproduced by an audio output device coupled to the audio synchronizer. The audio synchronizer may be wired to the audio output device or wirelessly connected to the audio output device. The audio output device may be any suitable audio device or system adapted to reproduce sound.

When configured as a stand-alone device, audio synchronizer 62 may be sized such that it is easily transported. For example, the device may be the size of a conventional cassette tape or portable cassette player, such that the device may is easily portable and may be carried in a pocket, bag, purse, etc.

As an illustration, and not as a limitation, audio synchronizer 62 may be a stand-alone device configured to be coupled to a portable radio. For example, the device may be linked to the portable radio with a mini-plug or other suitable wired or wireless connection. Audio signals from the radio may be transmitted to audio synchronizer 62, which may convert, modify (e.g. delay), reconvert, and transmit the modified audio broadcast out through a second wired or wireless connection, such as a mini-plug, to headphones, speakers, or other sound systems. Alternatively, the modified broadcast may be played through a sound system incorporated within the body of the audio synchronizer. Such embodiments may be relatively inexpensive to produce, thus being reasonable for an individual consumer to purchase and use.

The stand-alone audio synchronizer may include RCA jacks (or similar inputs) within the body of the audio synchronizer. The RCA jacks may be adapted to transfer line output from a radio or tuner into the audio synchronizer. Additionally, the modified audio broadcast may be transferred via RCA jacks, or another suitable input/output connections, into a sound generation unit of an audio output device, such as an amplifier and/or amplified speakers. The modified audio broadcast signal may also be directed into a television or television system with RCA line-in plugs or other suitable connectors.

Such an audio synchronizer further may include an on/off switch, time modification display, and a control configured to enable a user to adjust the audio signal as desired. It should be appreciated that such an audio synchronizer may be battery powered. Alternatively, the audio synchronizer may include an AC/DC adapter. Furthermore, the device may include an internal rechargeable battery that could be recharged by a built-in plug or AC plug-in charger.

As described above, in some embodiments, audio synchronizer 62 may be integrated within an audio device. The device may be hard wired or loaded into the audio device as software. Power may be supplied to audio synchronizer 62 via the power supply of the audio device. The audio device may be part of an audio system, a video system, and/or a computer system. For example, audio synchronizer 62 may be integrated within any one of a plurality of devices (referred to herein as master devices), which may be configured to receive audio signals and generate sound, including, but not limited to, a radio 64, a computer 66, a tuner or receiver (as illustrated at 68), a portable computer or handheld computing device 70, a television 72, a cellular phone 74, an amplifier, a car stereo, etc. Audio synchronizer 62 may use the circuitry of the master device. In an integrated system, controls for audio synchronizer 62 may be on the face of the master device, on a display on the master device, or accessible via known user input devices, such as remote controls used to program, use or control the master device.

For example, television 72, in addition to being configured to receive a television signal, the television may include a receiver configured to receive a radio signal. In other words, the television may include an FM/AM tuner. In such a television, audio synchronizer 62 may be adapted to enable a user to selectively adjust the audio broadcast to match the video portion of the television broadcast. For example, a user may mute the television audio, but continue to display the video portion of a television broadcast of an event. The user may then select an audio broadcast of the event, selectively adjust the timing of the audio broadcast using the audio synchronizer 62 to produce a modified audio broadcast. The user may adjust the audio broadcast to substantially correspond to the video display broadcast. The audio broadcast may be played through the television speakers.

Adjustment of the audio broadcast may be through the typical television controls, such as a remote control or on-screen programming. The user may then watch the video portion of the television broadcast while simultaneously listening to the modified audio broadcast emitted from the speakers within the television. In some embodiments, the user may selectively switch back and forth between the television audio and the radio audio at will.

Similarly, audio synchronizer 62 may be integrated within a computer, such as a personal computer 66, a hand held computer or portable computer 70, or other suitable computing device. Thus, audio synchronizer 62 may be configured to enable a user to selectively control an Internet broadcast or other audio broadcast such that the audio broadcast is synchronized with a video broadcast.

The following method is an example of how audio synchronizer 62 may be used to synchronize an audio signal of an event with a video display broadcast of the same event, when the audio synchronizer is integrated within a computer or other master device. For illustrative purposes, the audio signal may be an Internet broadcast or a radio broadcast. Generally, the method includes providing a connection to an audio information source, such as the Internet, through a computer or other device, and managing the audio received such that the audio broadcast is temporally modified.

Specifically, the method may include receiving an audio signal and directing the audio signal into the “audio” or microphone input of a computer. The method further may include temporarily saving and selectively delaying the audio in memory in the computer. In accordance with a selected delay period, the audio may be recovered from memory and then transmitted to one or more output jacks and played through headphones or other amplification system, such as computer speakers.

FIG. 4 shows generally, at 80, a method for selectively adjusting the reproduction of an audio broadcast to correlate with a video display broadcast of an event. The method includes, at 82, receiving an audio signal of an event. The audio signal is configured to generate an audio broadcast of the event. The method further includes, at 84, selectively adjusting the audio signal to produce a modified audio signal (which corresponds to a modified audio broadcast). The adjustment of the audio signal may include delaying the audio signal such that the modified audio broadcast temporally corresponds with a video broadcast. The method further includes outputting the modified audio signal to an audio output device.

While the present description has been provided with reference to the foregoing embodiments, those skilled in the art will understand that many variations may be made therein without departing from the spirit and scope defined in the following claims. The description should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring, nor excluding, two or more such elements.

What is claimed is:

1. An audio-synchronizing device comprising:
an audio input unit configured to receive an audio signal;
a user-adjustable control configured to enable a user to personally modify the audio signal to produce a modified audio signal corresponding to a video display broadcast; and
an audio output unit configured to output the modified audio signal to an output device.

2. The device of claim 1, wherein the user-adjustable control is adapted to enable a user to selectively delay the audio signal.

3. The device of claim 1, wherein the audio input unit includes an audio receiver.

4. The device of claim 1, wherein the audio signal is a radio broadcast.

5. The device of claim 1, wherein the output device is integrated within the audio-synchronizing device.

6. The device of claim 1, wherein the output device is external of the audio-synchronizing device.

7. The device of claim 1, wherein the output device is a radio.

8. The device of claim 1, wherein the output device is a television.

9. The device of claim 1, wherein the output device is a computer.

10. An audio synchronizer in an audio device, the audio synchronizer comprising:
an audio input unit configured to receive an audio signal from a radio broadcast;
a control configured to receive a user instruction regarding modification of the audio signal based on a television broadcast;
a processor configured to receive the audio signal from the audio input and modify the audio signal in accordance with the user instruction to create a modified audio signal; and
an audio output configured to output the modified audio signal as a modified audio broadcast.

11. The audio synchronizer of claim 10, wherein the control is configured to receive a user instruction regarding delaying the audio signal.

12. The audio synchronizer of claim 11, wherein the control is configured to enable a user to delay a radio broadcast of an event such that it generally corresponds to the television broadcast of the event.

13. The audio synchronizer of claim 12, wherein the event is a sporting event.

14. The audio synchronizer of claim 10, wherein the audio output unit is integrated within a radio.

15. The audio synchronizer of claim 10, wherein the audio output unit is integrated within a television.

16. The audio synchronizer of claim 10, wherein the control is a remote control.

17. A method for synchronizing an audio broadcast with a television broadcast, the method comprising:
receiving an audio signal from an audio transmission of an event;
selectively adjusting the audio signal to produce a modified audio broadcast that temporally corresponds with a video broadcast of the event; and
outputting the modified audio broadcast.

18. A system for synchronizing an audio broadcast with a television broadcast, the system comprising:
a display device configured to display a television broadcast of an event;
an audio receiver configured to receive an audio broadcast of the event;
an audio synchronizer linked to the audio receiver configured to temporally modify the audio broadcast to produce a modified audio broadcast which generally corresponds in time with the television broadcast; and
an audio output device configured to output the modified audio broadcast.

19. An audio synchronizing device for use when watching an event on a display device, the audio synchronizing device comprising:
means for receiving an audio broadcast of the event;
means for selectively adjusting the audio broadcast to produce a modified audio broadcast that temporally corresponds with the event on the display device; and
means for outputting the modified audio broadcast.

20. A program storage device readable by a machine, the storage device tangibly embodying a program of instructions executable by the machine to perform a method for synchronizing an audio broadcast with a television broadcast, the method comprising:
receiving an audio signal of an event;
delaying the audio signal to produce a modified audio broadcast that temporally corresponds with a video broadcast; and
outputting the modified audio broadcast to an output device.
